(19) United States
(12) Patent Application Publication
(10) Pub. No.: US 2023/0398718 A1
(43) Pub. Date: Dec. 14, 2023

(54) METHOD FOR RECYCLING TRAYS AND BLISTERS

(71) Applicant: ALPLA WERKE ALWIN LEHNER GMBH & CO. KG, Hard (AT)

(72) Inventor: Michael Heyde, Bergisch Gladbach (DE)

(21) Appl. No.: 18/248,229

(22) PCT Filed: Oct. 6, 2021
(86) PCT No.: PCT/EP2021/077599

§ 371 Date: Apr. 6, 2023

(30) Foreign Application Priority Data
Oct. 6, 2020 (CH) 01270/20

(51) Int. Cl. B29B 17/04; B08B 3/08; B29B 17/02

(52) U.S. Cl. CPC B29B 17/0412; B08B 3/08; B29B 17/02; B29B 2017/0015

(57) ABSTRACT

Method for recycling trays and blisters made of PET, which are referred to as articles, comprising the following method steps: (a) pre-sorting the articles, (b) comminuting the articles to form flakes, (c) washing the articles in a first washing step, (d) dewatering the flakes, (e) drying the flakes, (f) sorting the flakes, (g) extrusion, and (h) solid-state polycondensation (SSP). The first washing step (c) is a gentle washing step with reduced particle friction and a low temperature below 62° C. During the sorting of the flakes (f), the flakes, which have been gently washed in the first washing step (c), are sorted.

### CROSS-REFERENCE TO RELATED APPLICATIONS

This application is a national phase entry under U.S.C § 371 of PCT/EP2021/077599 filed Oct. 6, 2021, which claims priority to Swiss Patent Application No. 01270/20 filed Oct. 6, 2020, the entirety of each of which is incorporated by this reference.

### FIELD OF THE INVENTION

The invention relates to a method for recycling trays and blisters made of PET according to the preamble of claim 1.

### PRIOR ART

The recycling of PET bottles is prior art, and many PET bottles on the market already have a significant portion of PET recycling material of up to 100%.

Although PET trays and PET blister packs use PET recycling material from the bottle arena and also contain up to 100% recycling material, this is not in the sense of a closed circuit because the recycling quantities originate from the bottle market and are removed therefrom. As a result, both markets are affected by the legally prescribed recycling goals not being achieved because the rPET amounts from the bottle area are insufficient. Therefore, both markets, bottles and trays, have to be supplied for recycling in order to be able to meet the statutory requirements.

The reason why PET trays and blister packs themselves are not supplied in a closed recycling method (e.g.: tray to tray), is on the one hand related to the design of the tray and blister packs. For example, a great many blister packs are multi-layered. PET with an LDPE sealing layer, PET with an EVOH or polyamide barrier layer are common. On the other hand, the non-optimal washing, sorting and recycling methods are the reason.

In order to clean food residues (salad, paper, sauces) and other contaminants, such as adhesives, from the trays and blisters, a hot washing of 62 to 95° C. is currently used, wherein the washing agent is a strong alkaline solution having an NaOH concentration of between 1 and 3%. Under these conditions, contaminations generally dissolve very well but the PET becomes cloudy and brittle in these conditions. Regardless of whether the trays themselves are supplied as a whole to a washing process, or as cut material (flakes), a large part of the trays or flakes breaks up into particles of less than 2 mm (=fines or dust) in the subsequent process steps of drying, transport or sorting, so that sorting is no longer possible, especially in the case of a large proportion of multi-layered trays and flakes. The commercially available polymer sorters require a particle size greater than 2 mm for a good sorting performance.

EP 1 084 171 A1 discloses a method for recycling polyesters which leads to a recycled polyester of sufficient purity to meet the requirements or standards of foodstuff packaging. In the method, the collected polyester bottles are comminuted to form flakes. The flakes are washed and dried. After the flakes are melted, the melt is mixed with a melt of “virgin polyester” and extruded into pellets. The “post-consumer” melt can also first be extruded into pellets and then mixed with “virgin polyester” pellets. Finally, polymerization by SSP takes place.

However, this publication cannot provide answers to the specific problems related to trays and blisters made of PET that are described above.

### Advantages of the Invention

From the described disadvantages of the prior art, an advantage of the invention is to be able to recycle trays and blisters made of PET according to type and thus create a closed recycling cycle for trays and blisters.

Another advantage of the invention is to define a washing process that allows common polymer sorting systems to remove foreign polymers made of flakes from the stream of washed trays and the blister stream and to thereby supply this packaging stream to a high-quality recycling.

### SUMMARY OF THE INVENTION

The advantages are achieved in a method for recycling trays and blisters made of PET according to the invention set forth in claim 1. Developments and/or advantageous alternative embodiments form the subject matter of the dependent claims.

The invention comprises a gentle washing step with minimal particle friction and a low temperature below 62° C. in a basic medium, or a gentle washing step with minimal particle friction and a low temperature in an acidic medium below 85° C., and that the flakes that are washed gently in the first washing step are sorted in the flake sorting. As a result of the gentle first washing step, the flakes have a size of more than 2 mm after washing and are still able to be sorted with conventional sorting devices after the washing. The formation of flakes having a size of less than 2 mm, or so-called fines, which can no longer be sorted, is prevented by the gentle first washing step. On account of their properties caused by the initial use in recycling processes according to the prior art, trays and blisters made of PET become brittle in such a way that the resulting fines can no longer be technically recovered. The present adapted recycling process makes it possible, due to the reduced temperature and the low particle friction, for the flakes to have a size which does not fall below 2 mm before sorting and as a result are still able to be sorted. The low particle friction is achieved by the smallest possible introduction of mechanical energy during the first washing step.

In an alternative embodiment, the first washing step is carried out below 85° C. in an acid with a pH of 1 to 3 and for a washing time of 60 to 600 min. Even under these washing conditions, flakes with an undesired size of less than 2 mm are not produced during the first washing step.

In another embodiment of the invention, after the flake sorting a second intensive washing step is carried out with a temperature between 70 and 90° C., increased particle friction and in the basic environment. If an intensive cleaning of the flakes is necessary, for example if food is packaged into the trays and blister packs produced from the flakes, or if transparent trays or blisters are produced from the pellets, flakes having a size of less than 2 mm must be produced in this second washing step. These small flakes no longer interfere with the sorting because the sorting was performed before the second intensive washing step. In the further processing of the flakes after the second washing step, the size of the flakes is unimportant for the quality of the rPETs. Therefore, the flake sorting does not take place directly before the extrusion as is customary in the prior art but instead is moved to the middle of the washing process.

It has proven expedient if a pre-washing of the articles is provided after the pre-sorting. The pre-washing of the trays and blisters makes it possible for the flakes to be cleaned sufficiently despite the gentle first washing step.

In a further alternative embodiment, the solid-state polycondensation is carried out before the extrusion.

The first washing step is expediently carried out at in an alkaline solution concentration of 1.2 to 2.5 wt. % and for a washing time of 5 to 50 minutes. These washing conditions do not lead to an undesired reduction of the flakes to less than 2 mm.

In the invention, fast-running stirrers and so-called mechanical dryers, which place an intense mechanical load on the material, are avoided and are replaced by slow-running stirrers in the washing and by centrifuges and air flows in the dewatering/drying, so that the mechanical energy, measured by the electrical consumption of the electric motors, is below 10 Wh/kg PET regenerated material. As a result the particle friction, which can lead to undesired comminution of the flakes, is reduced as much as possible.

In a further embodiment of the invention, the drying step is a thermal drying by air flow. This type of drying is particularly gentle, as a result of which the flakes do not run the risk of becoming comminuted during drying.

It proves advantageous if the flakes have a water content of less than 5% after the drying step. As a result, the flakes can be sorted more precisely because the water cannot distort the sorting.

It is advantageous if the smallest extension of the flakes is greater than 2 mm and the extension of the flakes is between 4 and 18 mm or more advantageously between 5 and 15 mm. As a result, the method is surprisingly suitable for producing rPET pellets from trays and blisters which are freed of foreign materials and coatings by sorting. In the range of flake size above, the sorting can be done particularly precisely.

Expediently, a greater friction is exerted on the flakes in the second washing step than in the first washing step. As a result, the cleaning performance in the second washing step can be increased. The inevitable comminution of the flakes due to the increased friction is irrelevant because the sorting of the flakes is carried out before the second washing step.

The solid-state polycondensation can be carried out after the extrusion to form the rPETs. For example, the SSP step can be performed on extruded staple fibers or on an extruded film. The condensation by removal of water is carried out on the extruded product at a temperature between 185° C. and 245° C.

### BRIEF DESCRIPTIONS OF THE DRAWINGS

Further advantages and features become apparent from the following description of a plurality of exemplary embodiments of the invention with reference to the schematic block diagrams. The following are shown:

FIG. 1: a block diagram of a method for recycling PET bottles as known from the prior art;

FIG. 2: a block diagram of a basic method for recycling PET trays and blisters;

FIG. 2a: a first variant of the method as shown in the block diagram of FIG. 2;

FIG. 2b: a second variant of the method as shown in the block diagram of FIG. 2; and

FIG. 2c: a third variant of the method as shown in the block diagram of FIG. 2.

### DETAILED DESCRIPTION OF THE INVENTION

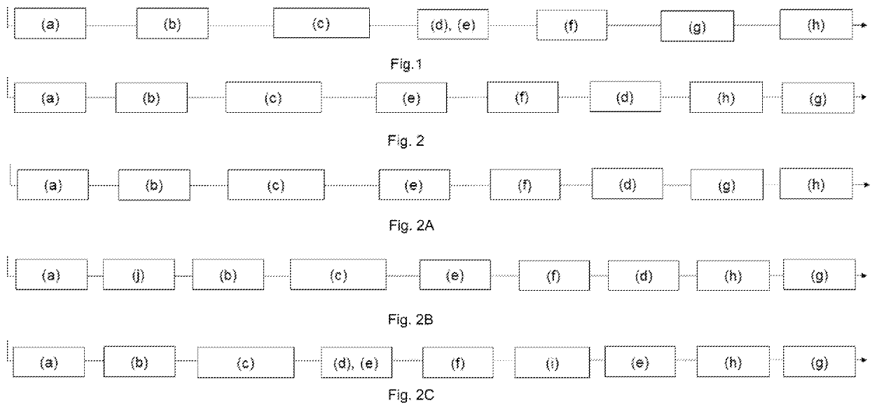

A block diagram of a method for recycling PET bottles is shown in FIG. 1. The method comprises the following steps:
(a) pre-sorting the collected bottles,
(b) comminuting the bottles to form flakes,
(c) washing the bottles in a washing step,
(d) dewatering the flakes,
(e) drying the flakes,
(f) sorting the flakes,
(g) extrusion and
(h) solid-state polycondensation (SSP).

The washing step (c) is a multi-stage intensive hot washing with alkaline solution and detergents. After the SSP, the pellets made of rPET produced by extrusion (g) can be processed again to form bottles.

The result is PET trays and blister packs which are collectively referred to as articles. Experiments on the articles and flakes therefrom have surprisingly shown that they behave differently than bottles and flakes from bottles in the alkaline bath. The process control must therefore be adapted to this recycling material so that the recycling material has a sufficient quality for recycling. PET bottle material is semi-crystalline (stretched) in the thin-walled regions and amorphous (unstretched) in the thick-walled regions. The tray and blister material for the recycling process differs significantly here. There are very many amorphous thin-walled regions and very few semi-crystalline (stretched regions). The crystallinity in these semi-crystalline regions is also much lower.

Amorphous PET is significantly more brittle than semi-crystalline PET; the thinner the PET flake, the more likely that stress will result in breakage. Unfortunately, this tendency toward breakage is increased by a second property of the polyester: semi-crystalline PET from the bottle application is only slightly attacked by alkaline solutions because the crystallinity suppresses the tendency toward stress cracks. However, as occurs to a greater degree in the case of tray and blister material, amorphous PET is very sensitive to alkaline solutions and tends toward stress cracks. The surface of the trays which is damaged by the alkaline solution therefore tends much more toward fractures and consequently to the formation of dust.

Because many of the articles are produced only with low deformation energies, a slightly reduced viscosity of 0.62 to 0.76 dl/g according to ASTM D4603 is often used for these articles, which is below the typical viscosities of bottle material. The low viscosity of the tray and blister material makes the amorphous PET even more brittle and even more sensitive to the washing liquor, and leads to even more minimal stretching. If the tray and blister material were to be reprocessed according to the method according to FIG. 1, the flakes would no longer be able to be sorted because, due to the intensive washing step, they break up to a large extent into small particles of less than 2 mm (so-called fines), which can no longer be sorted. As a result, undesired foreign bodies would remain in the recycling stream, which greatly reduce its quality.

Therefore, the flake sorting (f) is moved to the middle of the washing process, as a result of which an early flake sorting is carried out. The washing process is a first gentle washing step (c) in which no “fines” are produced that can no longer be sorted. In order to achieve this, a low particle friction is present in the first washing step (c) and the washing temperature is below 62° C. in a basic medium. The first washing step (c) is carried out at an alkaline concentration of 1.2 to 2.5 wt. % and a washing time of 5 to 50 min. As a result of the first gentle washing step, individual flakes stay in the size from 2 to 20 mm and ideally in the size between 4 and 18 mm and do not break when bent 90° about a radius of 1 mm. As shown in FIGS. 2, 2a and 2b, the sorting of the flakes is between the dewatering of the flakes (d) and the drying of the flakes (e). During the dewatering, the flakes can still also be dried.

Alternatively, the first washing step can be carried out at 85° C. with an acid having a pH of 1 to 3, with a duration of 60 to 600 min. In this variant of the first washing step (c) too, individual flakes stay in the size from 2 to 20 mm and ideally between 4 and 18 mm and do not break when bent 90° about a radius of 1 mm.

As shown in FIGS. 2, 2a, 2b and 2c, the flakes are sorted directly after the first washing step (c) and the drying (e) of the flakes in the flake sorting (f). Further method steps are carried out only after the flake sorting (f). This ensures that the flakes have a sufficient size, and consequently foreign bodies can be reliably separated from the flakes by customary sorting devices.

In and after washing step (c), stirrers are usually used, in particular during the neutralization and the drying step (e). The articles or the flakes are not mechanically stressed by stirrers, but instead are treated gently by corresponding mechanical dewatering devices and air flows without the flakes being comminuted in an undesired manner. Stirrers are used only in the washing and neutralization process, so that the mechanical energy, measured by the electrical consumption of the electric motors, is below 10 Wh/kg PET regenerated material.

For the subsequent method step of the flake sorting process, the flakeware is present in flake form which is over 90% dry (water content below 5%) and which is over 2 mm in its largest dimension. The drying of the flakes (e) is a gentle thermal drying. The drying of the flakes (e) can be omitted if the flakes are sufficiently dry. For the relevant sorting size, the real deformed maximum dimension applies rather than the rolled maximum dimension. For optimal sorting, flake sizes need to be between 4 and 18 mm and, due to the present first washing step and the gentle drying, do not fall below this.

As a result, a polymer sorter can be used which, by means of infrared and near infrared reflection and transmission, detects and sorts out multilayer structures of the PET with polyolefins, in particular LDPE, polyamides, in particular MXD6, and other barrier layers, such as EVOH and PGA.

As a result, it is also possible to use an ink sorter which, in particular, separates yellow PET via oxygen scavenger.

The flake sorting (f) and high-quality pure recycled material are only possible without dust formation (fines).

Alternatively, a second hot washing step (i) at 70 to 90° C. with intensive friction after the flake sorting (f) can be added to the method (FIG. 2c). This may be necessary, for example, if the regenerated material is formed into trays and blisters into which foodstuffs are packaged because high hygiene requirements are then placed on the packaging.

The first washing step (c) is gently maintained by the low temperature and friction in such a way that an optimal sorting is possible. The second washing step (i) can be carried out hotly and with intense friction without restrictions for optimal flake sorting (f) (FIG. 2c). If in this second washing step (i) the flakes are comminuted and fines are formed, and therefore can no longer be sorted, this does not represent a problem because no further sorting is necessary.

These flakes can be processed directly or after further drying of the flakes (e) to form PET trays or blisters again in an extrusion (g) with degassing.

In an alternative embodiment, flakes can also be condensed before the extrusion (g) by a solid-state polycondensation (SSP) (h) as an alternative to or in addition to the drying (e). This alternative SSP (h) can take place directly from the flakes and also from comminuted flakes (powder SSP). This alternative embodiment is shown in FIGS. 2, 2b and 2c.

As shown in FIG. 2b, a pre-washing (j) of the blisters and/or trays can be carried out before the comminution (b).

1. Method for recycling PET articles in the form of trays and blisters, comprising the following method steps:
pre-sorting PET articles,
comminuting the sorted PET articles to form PET flakes,
gently washing the PET flakes in a first washing step performed with reduced particle friction between PET flakes to limit breakage of the PET flakes and performed at a temperature below 62° C. in a basic medium or performed at a temperature below 85° C. in an acidic medium,
dewatering the PET flakes,
drying the PET flakes,
sorting PET flakes that have been gently washed,
performing solid-state polycondensation on the sorted PET flakes, and
extruding the PET flakes.

2. Method according to claim 1, further comprising intensely washing the PET flakes after the sorting of the PET flakes in a second washing step performed at a temperature between 70 and 90° C. in a basic environment and performed with increased particle friction.

3. Method according to claim 1, further comprising pre-washing the PET articles after the pre-sorting the PET articles.

4. Method according to claim 1, wherein the performing the solid-state polycondensation on the sorted PET flakes is performed before the extruding.

5. Method according to claim 1, wherein the first washing is performed in the basic medium having an alkaline solution concentration of 1.2 to 2.5 wt. % for 5 to 50 minutes.

6. Method according to claim 1, wherein the first washing step is performed in the acidic medium having a pH of 1 to 3 for 60 to 600 minutes.

7. Method according to claim 1, further comprising replacing fast running stirrers and mechanical dryers, which place an intense mechanical load on the PET flakes, with slow-running stirrers in the first washing step and by centrifuges and air flows in the dewatering/and drying, so that mechanical energy, measured by an electrical consumption of electric motors used to operate process equipment, is below 10 Wh/kg PET regenerated material.

8. Method according to claim 1, wherein the drying comprises thermal drying via air flow.

9. Method according to claim 1, wherein the drying the PET flakes comprises drying the PET flakes to have a water content of less than 5%.

10. Method according to claim 1, wherein a smallest size of the PET flakes is greater than 2 mm and most of the PET flakes range in size between 4 mm and 18 mm, or between 5 mm and 15 mm.

11. Method according to claim 2, wherein greater friction is exerted on the PET flakes in the second washing step than in the first washing step.

12. Method according to claim 1, wherein the extruding comprises extruding the PET flakes into spun fibers and the solid-state polycondensation is performed on the spun fibers.

13. Method according to claim 1, wherein the extruding comprises extruding the PET flakes into a film and the solid-state polycondensation is performed on the film.

14. Method according to any of claim 12, wherein the solid-state polycondensation affected by withdrawal of water from the spun fibers at a temperature between 185° C. and 245° C.

15. Method according to any of claim 13, wherein the solid-state polycondensation is affected by withdrawal of water from the film at a temperature between 185° C. and 245° C.
